(19) United States
(12) Patent Application Publication
(10) Pub. No.: US 2024/0248323 A1
(43) Pub. Date: Jul. 25, 2024

(54) LENS DEVICE

(71) Applicant: FUJIFILM Corporation, Tokyo (JP)

(72) Inventors: Nobuyuki KONDO, Saitama-shi (JP); Mitsuhiko OKA, Saitama-shi (JP)

(73) Assignee: FUJIFILM Corporation, Tokyo (JP)

(21) Appl. No.: 18/408,570

(22) Filed: Jan. 10, 2024

(30) Foreign Application Priority Data
Jan. 20, 2023 (JP) 2023-007595

(51) Int. Cl. G02B 27/64; G02B 7/02

(52) U.S. Cl. CPC G02B 27/64; G02B 7/021

(57) ABSTRACT

A lens device includes a lens mechanism, a tilt mechanism that tilts the lens mechanism, and a shift mechanism that shifts the lens mechanism, in which the lens mechanism includes a lens holding member that holds a lens and that moves in an optical axis direction, a movement member that moves in the optical axis direction and that is positioned at an end portion of the lens mechanism that is on an object side, and a rotary member that rotates around the optical axis direction, and the rotary member includes a first groove that engages with the lens holding member and a second groove that engages with the movement member.

### CROSS-REFERENCE TO RELATED APPLICATIONS

This application claims priority under 35 USC 119 from Japanese Patent Application No. 2023-007595 filed on Jan. 20, 2023, the disclosure of which is incorporated by reference herein.

### BACKGROUND OF THE INVENTION

### 1. Field of the Invention

The present disclosed technology relates to a lens device.

### 2. Description of the Related Art

Disclosed in JP2021-051182A is a lens barrel. The lens barrel includes a lens holding frame that holds a lens, a first frame that is different from the lens holding frame, and a driving unit that is provided at one of the first frame or the lens holding frame and that drives the other of the first frame or the lens holding frame in a direction intersecting an optical axis based on at least one of a focal length, a camera-to-subject distance, or the position of the lens in an optical axis direction.

Disclosed in JP2020-154006A is an adjustment mechanism that adjusts, within a plane intersecting an optical axis direction of an optical system composed of a plurality of lenses, the position of a predetermined lens in the optical system. The adjustment mechanism includes at least a pair of adjustment units. Each adjustment unit includes a basing portion that biases the predetermined lens to a central axis side and a positioning portion that determines the in-plane position of the predetermined lens biased by the biasing portion. The positioning portion includes a first screwing member that includes a first screwing portion and a second screwing portion, a second screwing member that is screwed with the first screwing portion and against which the predetermined lens biased by the biasing portion is pressed so that the in-plane position of the predetermined lens is determined, and a fixing member that includes a screwing portion screwed with the second screwing portion. Each of the second screwing member and the fixing member is prevented from rotating.

Disclosed in JP2016-145969A is a lens barrel. The lens barrel includes a cam tube, a first tube that is fitted to the cam tube and that moves in an optical axis direction as the cam tube rotates, and a second tube that supports a lens holding member moving in a direction different from the optical axis direction for image shake correction, that is fitted to the cam tube, and that moves in the optical axis direction as the cam tube rotates. The second tube includes a first vibration suppression pin that engages with the first tube to be movable in the optical axis direction.

### SUMMARY OF THE INVENTION

One embodiment according to the present disclosed technology provides, for example, a lens device in which movement of a lens holding member holding a lens and movement of a movement member positioned at an end portion of a lens mechanism that is on an object side can be performed independently of each other.

A lens device according to a first aspect of the present disclosed technology includes a lens mechanism, a tilt mechanism that tilts the lens mechanism, and a shift mechanism that shifts the lens mechanism. The lens mechanism includes a lens holding member that holds a lens and that moves in an optical axis direction, a movement member that moves in the optical axis direction and that is positioned at an end portion of the lens mechanism that is on an object side, and a rotary member that rotates around the optical axis direction, and the rotary member includes a first groove that engages with the lens holding member and a second groove that engages with the movement member.

According to a second aspect of the present disclosed technology, in the lens device related to the first aspect, a specific gravity of the movement member may be equal to or smaller than a specific gravity of the rotary member.

According to a third aspect of the present disclosed technology, in the lens device related to the first aspect or the second aspect, the movement member may be a member related to an accessory member that affects an optical performance of the lens.

According to a fourth aspect of the present disclosed technology, in the lens device related to any one of the first to third aspects, the movement member may be a lens hood.

According to a fifth aspect of the present disclosed technology, in the lens device related to any one of the first to fourth aspects, the movement member may be an attachment member to which an optical member is attachable.

According to a sixth aspect of the present disclosed technology, in the lens device related to any one of the first to fifth aspects, the first groove and the second groove may constitute a cam mechanism that moves the lens holding member and the movement member together with each other in the optical axis direction as the rotary member rotates.

According to a seventh aspect of the present disclosed technology, in the lens device related to any one of the first to sixth aspects, the first groove may be a first cam groove along which the lens holding member is moved in the optical axis direction as the rotary member rotates and the second groove may be a second cam groove along which the movement member is moved in the optical axis direction as the rotary member rotates.

According to an eighth aspect of the present disclosed technology, in the lens device related to any one of the first to seventh aspects, a first pitch, which is a cam pitch of the first groove, may be different from a second pitch, which is a cam pitch of the second groove.

According to a ninth aspect of the present disclosed technology, in the lens device related to the eighth aspect, the second pitch may be smaller than the first pitch.

According to a tenth aspect of the present disclosed technology, in the lens device related to any one of the first to ninth aspects, the lens holding member may have a first engagement position which is a position where the lens holding member engages with the first groove, the movement member may have a second engagement position which is a position where the movement member engages with the second groove, and a second distance may be smaller than a first distance, where the first distance is a distance between the first engagement position and the second engagement position in the optical axis direction in a first state, which is a state where the lens holding member and the movement member have been moved to an image formation side opposite to the object side and the second distance is a distance between the first engagement position and the second engagement position in the optical axis direction in a second state, which is a state where the lens holding member and the movement member have been moved to the object side.

According to an eleventh aspect of the present disclosed technology, in the lens device according to the tenth aspect, the first engagement position and the second engagement position in the first state may be positioned closer to the image formation side than the first engagement position and the second engagement position in the second state are.

According to a twelfth aspect of the present disclosed technology, in the lens device related to the tenth aspect or the eleventh aspect, the first state may be a state where infinite-distance imaging is performed and the second state may be a state where short-distance imaging is performed.

According to a thirteenth aspect of the present disclosed technology, in the lens device related to any one of the first to twelfth aspects, the first groove may be a groove of which at least a portion in a lengthwise direction of the first groove includes a bottom portion.

According to a fourteenth aspect of the present disclosed technology, in the lens device related to any one of the first to thirteenth aspects, the first groove may be a groove that includes a bottom portion over an entire length of the first groove in a lengthwise direction.

According to a fifteenth aspect of the present disclosed technology, in the lens device related to any one of the first to fourteenth aspects, the second groove may be a groove of which at least a portion in a lengthwise direction of the second groove penetrates the rotary member in a radial direction.

According to a sixteenth aspect of the present disclosed technology, in the lens device related to any one of the first to fifteenth aspects, the second groove may be a groove that penetrates the rotary member in a radial direction over an entire length of the second groove in a lengthwise direction.

According to a seventeenth aspect of the present disclosed technology, in the lens device according to any one of the first to sixteenth aspects, a first width, which is a width of the first groove, may be different from a second width, which is a width of the second groove.

According to an eighteenth aspect of the present disclosed technology, in the lens device related to the seventeenth aspect, the second width may be smaller than the first width.

According to a nineteenth aspect of the present disclosed technology, in the lens device related to any one of the first to eighteenth aspects, the first groove may be formed independently of the second groove.

According to a twentieth aspect of the present disclosed technology, in the lens device related to any one of the first to nineteenth aspects, the second groove may be positioned on the object side with respect to the first groove.

According to a twenty-first aspect of the present disclosed technology, in the lens device according to any one of the first to twentieth aspects, the lens holding member may include a first engaging member that engages with the first groove and the movement member may include a second engaging member that engages with the second groove.

According to a twenty-second aspect of the present disclosed technology, the lens device related to any one of the first to twenty-first aspects may further include a support member that supports the lens holding member, the movement member, and the rotary member.

According to a twenty-third aspect of the present disclosed technology, in the lens device related to the twenty-second aspect, the rotary member may include a positioning portion via which the rotary member is positioned with respect to the support member in the optical axis direction.

According to a twenty-fourth aspect of the present disclosed technology, in the lens device related to the twenty-third aspect, the positioning portion may be provided at an end portion of the rotary member that is on the object side.

According to a twenty-fifth aspect of the present disclosed technology, in the lens device related to any one of the twenty-second to twenty-fourth aspects, the lens holding member may be disposed inside the support member and the movement member and the rotary member may be disposed outside the support member.

According to a twenty-sixth aspect of the present disclosed technology, in the lens device according to any one of the twenty-second to twenty-fifth aspects, the lens holding member may include a first engaging member that engages with the first groove, the movement member may include a second engaging member that engages with the second groove, the support member may include a long hole that penetrates the support member in a radial direction and that extends in the optical axis direction, and the first engaging member and the second engaging member may be inserted into the long hole.

### BRIEF DESCRIPTION OF THE DRAWINGS

FIG. 1 is a perspective view showing an example of an imaging apparatus.

FIG. 2 is a plan view showing an example of a lens device.

FIG. 3 is a side view showing an example of the lens device.

FIG. 4 is a longitudinal cross-sectional view showing an example of the lens device.

FIG. 5 is a side view showing an example of a lens mechanism.

FIG. 6 is a longitudinal cross-sectional view showing an example of the lens mechanism.

FIG. 7 is a cross-sectional view taken along line F7-F7 in FIG. 5.

FIG. 8 is a cross-sectional view taken along line F8-F8 in FIG. 5.

FIG. 9 is a perspective view showing an example of a cam tube.

FIG. 10 is a side view showing the example of the cam tube.

FIG. 11 is a side view of the cam tube which shows an example of a first cam groove and a second cam groove.

FIG. 12 is an explanatory view showing an example of the operation of the lens mechanism with a side view.

FIG. 13 is an explanatory view showing an example of the operation of the lens mechanism with a longitudinal cross-sectional view.

### DESCRIPTION OF THE PREFERRED EMBODIMENTS

First, the configuration of an imaging apparatus 10 according to an embodiment of the present disclosure will be described.

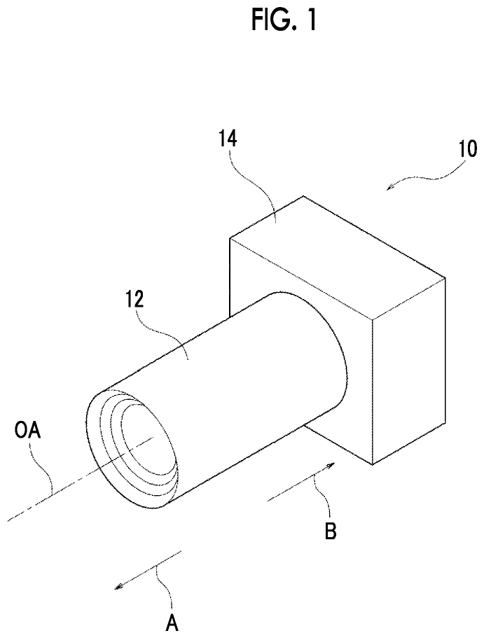

FIG. 1 shows a perspective view of the imaging apparatus 10 according to the present embodiment. For example, the imaging apparatus 10 includes a lens device 12 and an imaging apparatus body 14 as shown in FIG. 1. The lens device 12 is provided at a front portion of the imaging apparatus body 14. In FIG. 1, the lens device 12 and the imaging apparatus body 14 are schematically shown. An image sensor (not shown), a computer (not shown), and the like are built into the imaging apparatus body 14. Regarding the lens device 12, an arrow A side is an object side, and an arrow B side is an image formation side. An optical axis OA is an optical axis of the lens device 12. Hereinafter, an axial direction along the optical axis OA will be referred to as an “optical axis direction”.

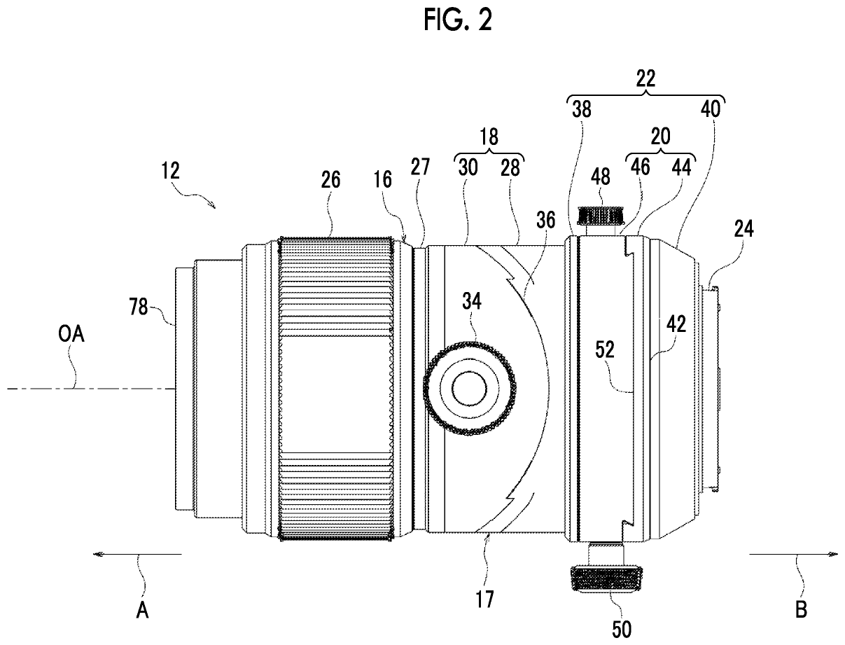

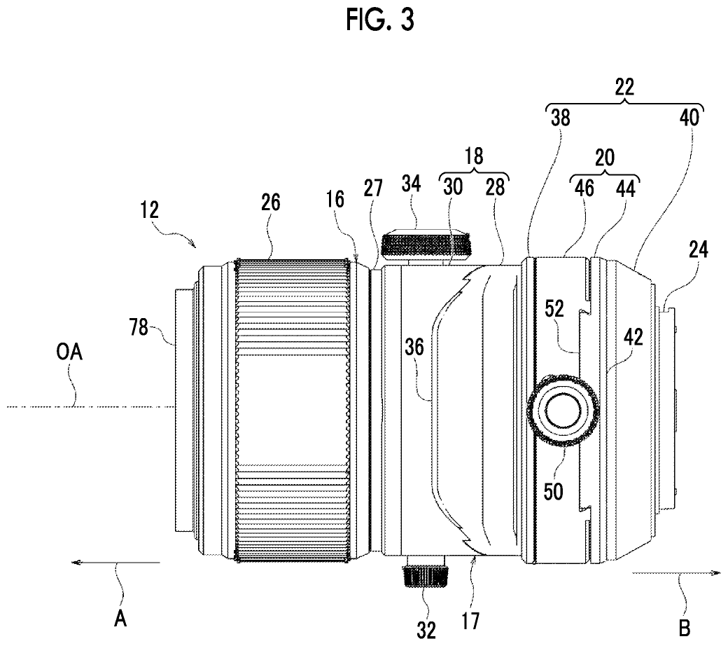

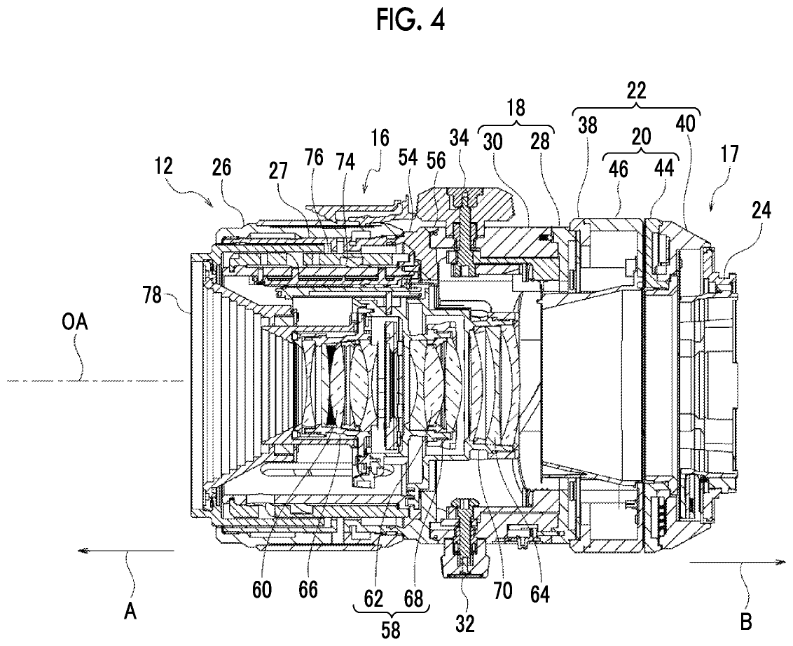

FIG. 2 shows a plan view of the lens device 12 and FIG. 3 shows a side view of the lens device 12. In addition, FIG. 4 shows a longitudinal cross-sectional view (that is, a cross-sectional side view) of the lens device 12. For example, as shown in FIGS. 2 to 4, the lens device 12 includes a lens mechanism 16 and a tilt-shift unit 17. The tilt-shift unit 17 includes a tilt mechanism 18, a shift mechanism 20, a revolving mechanism 22, and a mount 24.

The lens mechanism 16 is disposed on the object side with respect to the tilt mechanism 18 and the shift mechanism 20. The lens mechanism 16 includes a focus ring 26 and a lens barrel 27. Each of the focus ring 26 and the lens barrel 27 is formed around the optical axis direction in an annular shape. The lens barrel 27 is disposed inside the focus ring 26. In the description of the present specification, the term “inside” means “inside in a radial direction” unless there is no description in which a direction is specified. The focus ring 26 is supported to be rotatable around the optical axis direction with respect to the lens barrel 27.

A first flange 54 is formed at an end portion of the lens barrel 27 that is on the image formation side and a second flange 56 is formed at an end portion (specifically, an end portion of a tilt stage 30 (which will be described later) that is on the object side) of the tilt-shift unit 17 that is on the object side. The first flange 54 and the second flange 56 are fastened by screws or the like (not shown) in a state of overlapping with each other, so that the lens mechanism 16 is fixed to the tilt-shift unit 17.

The tilt mechanism 18 is a mechanism that tilts the lens mechanism 16. The tilt mechanism 18 includes a tilt base 28, the tilt stage 30, a tilt lock 32, and a tilt knob 34. A boundary 36 is a boundary between the tilt base 28 and the tilt stage 30. The boundary 36 is formed in an arc-like shape while being centered on a tilt shaft (not shown) orthogonal to the optical axis OA. The tilt mechanism 18 acts with the boundary 36 as a starting point. In the description of the present specification, the meaning of “being orthogonal” includes not only “being completely orthogonal” but also “being orthogonal with an error generally acceptable in a technical field to which the present disclosed technology belongs to an extent that is not inconsistent with the gist of the present disclosed technology”.

The tilt stage 30 is disposed closer to the object side than the tilt base 28 is. The tilt stage 30 is fixed to the lens mechanism 16. Specifically, the tilt stage 30 is fixed to the lens barrel 27. The tilt base 28 supports the tilt stage 30 such that the tilt stage 30 can tilt. The meaning of “to tilt” is an operation of rotationally moving about the tilt shaft. The tilt stage 30 tilts integrally with the lens mechanism 16.

The tilt lock 32 and the tilt knob 34 are shaft-shaped members. The tilt lock 32 is disposed with an axial direction of the tilt lock 32 being parallel with an axial direction of the tilt shaft. Similarly, the tilt knob 34 is disposed with an axial direction of the tilt knob 34 being parallel with the axial direction of the tilt shaft. In the description of the present specification, the meaning of “being parallel with each other” includes not only “being completely parallel with each other” but also “being parallel with each other with an error generally acceptable in a technical field to which the present disclosed technology belongs to an extent that is not inconsistent with the gist of the present disclosed technology”. The tilt lock 32 and the tilt knob 34 are provided at the tilt stage 30.

The tilt lock 32 is a member that can switch between a locking state in which the tilt stage 30 is fixed to the tilt base 28 and an unlocking state in which the tilt stage 30 is allowed to tilt. The tilt knob 34 is a member that tilts the tilt stage 30. For example, a rack-and-pinion mechanism (not shown) is provided between the tilt knob 34 and the tilt stage 30 and the tilt stage 30 tilts by an amount of movement corresponding to the amount of rotation of the tilt knob 34.

The revolving mechanism 22 is a mechanism that rotates the lens mechanism 16, the tilt mechanism 18, and the shift mechanism 20. The revolving mechanism 22 includes a revolving stage 38 and a revolving base 40. A boundary 42 is a boundary between the revolving base 40 and a shift base 44 which will be described later. The boundary 42 is formed along a plane orthogonal to the optical axis OA. The revolving mechanism 22 acts with the boundary 42 as a starting point.

The revolving stage 38 is disposed closer to the image formation side than the tilt base 28 is. The revolving stage 38 is fixed to the tilt base 28. The revolving base 40 is disposed closer to the image formation side than the shift base 44 is. The revolving base 40 supports the shift base 44 to be rotatable around the optical axis direction. The lens mechanism 16, the tilt mechanism 18, the revolving stage 38, and the shift mechanism 20 integrally rotate with each other around the optical axis direction. The lens mechanism 16, the tilt mechanism 18, the revolving stage 38, and the shift mechanism 20 rotate in a case where a force in a rotation direction is applied by a user or the like. The revolving mechanism 22 is an example of a “rotation mechanism” according to an embodiment of the present disclosed technology.

The shift mechanism 20 is a mechanism that shifts the lens mechanism 16 and the tilt mechanism 18. The shift mechanism 20 includes the shift base 44, a shift stage 46, a shift lock 48, and a shift knob 50. A boundary 52 is a boundary between the shift base 44 and the shift stage 46. The boundary 52 is formed along a plane orthogonal to the optical axis OA. The shift mechanism 20 acts with the boundary 52 as a starting point.

The shift stage 46 is disposed closer to the image formation side than the revolving stage 38 is. The shift stage 46 is fixed to the revolving stage 38. The shift base 44 is disposed closer to the image formation side than the shift stage 46 is. The shift base 44 supports the shift stage 46 such that the shift stage 46 can shift. The meaning of “to shift” is an operation of sliding in a direction orthogonal to the optical axis direction. The shift stage 46 integrally shifts with the lens mechanism 16, the tilt mechanism 18, and the revolving stage 38. For example, a direction in which the shift stage 46 shifts (hereinafter, referred to as a “shift direction”) is set to a vertical direction of the imaging apparatus 10 (refer to FIG. 1).

The shift lock 48 and the shift knob 50 are shaft-shaped members. The shift lock 48 is disposed with an axial direction of the shift lock 48 being parallel with a direction orthogonal to the optical axis direction and the shift direction. Similarly, the shift knob 50 is disposed with an axial direction of the shift knob 50 being parallel with the direction orthogonal to the optical axis direction and the shift direction. The shift lock 48 and the shift knob 50 are provided at the shift stage 46.

The shift lock 48 is a member that can switch between a locking state in which the shift stage 46 is fixed to the shift base 44 and an unlocking state in which the shift stage 46 is allowed to shift. The shift knob 50 is a member that shifts the shift stage 46. For example, a rack-and-pinion mechanism (not shown) is provided between the shift knob 50 and the shift base 44 and the shift stage 46 shifts by an amount of movement corresponding to the amount of rotation of the shift knob 50.

The mount 24 is provided at an end portion of the lens mechanism 16 that is on the image formation side. The mount 24 is fixed to the revolving base 40. The mount 24 is attached to a mount (not shown) provided on the imaging apparatus body 14 (refer to FIG. 1). The lens device 12 is fixed to the front portion of the imaging apparatus body 14 in a case where the mount 24 is attached to the mount provided on the imaging apparatus body 14. The mount 24 is disposed inside the revolving base 40. The revolving base 40 functions as a rear cover that covers the mount 24 provided at the end portion of the lens mechanism 16 that is on the image formation side.

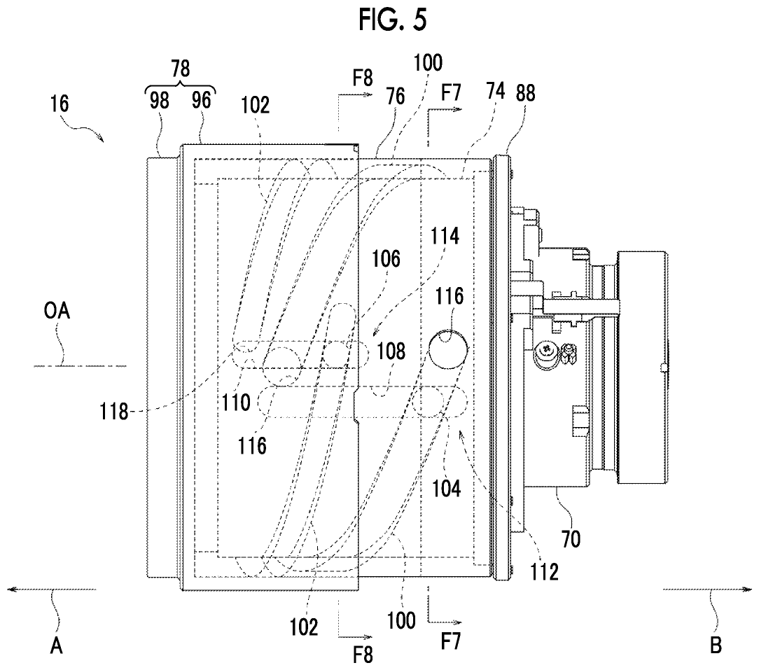

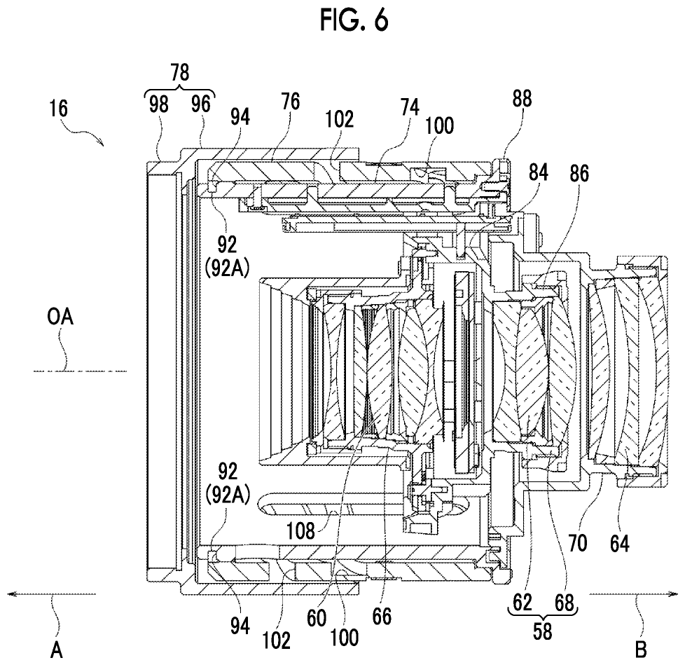

FIG. 5 shows a side view of the lens mechanism 16 and FIG. 6 shows a longitudinal cross-sectional view of the lens mechanism 16. For example, as shown in FIGS. 5 and 6, the lens mechanism 16 includes first lenses 60, second lenses 62, third lenses 64, a first lens frame 66, a second lens frame 68, a third lens frame 70, a fixation frame 74, a cam tube 76, and a movement member 78. Each of the first lens frame 66, the second lens frame 68, the third lens frame 70, the fixation frame 74, the cam tube 76, and the movement member 78 is formed around the optical axis direction in an annular shape. Note that the annular shape may be regarded as a tubular shape.

For example, the first lenses 60 are objective lenses, the second lenses 62 are focus lenses, and the third lenses 64 are fixed focal lenses. The first lenses 60 are disposed closer to the object side than the second lenses 62 are and the third lenses 64 are disposed closer to the image formation side than the second lenses 62 are. The second lenses 62 are examples of a “lens” and a “focus lens” according to an embodiment of the present disclosed technology.

The first lenses 60 are disposed inside the first lens frame 66, the second lenses 62 are disposed inside the second lens frame 68, and the third lenses 64 are disposed inside the third lens frame 70. The first lens frame 66 holds the first lenses 60, the second lens frame 68 holds the second lenses 62, and the third lens frame 70 holds the third lenses 64. The second lens frame 68 and the second lenses 62 constitute a focus lens group 58. The second lens frame 68 is an example of a “lens holding member” according to an embodiment of the present disclosed technology.

The second lens frame 68 includes a first frame 84 and a second frame 86. The first frame 84 is provided closer to the object side than the second frame 86 is. The second lenses 62 are disposed inside the second frame 86. The second lenses 62 and the second frame 86 protrude toward the image formation side with respect to the fixation frame 74 and are disposed inside the tilt mechanism 18, the shift mechanism 20, and the revolving mechanism 22 (refer to FIG. 4). The first frame 84 is disposed closer to the object side than the second lenses 62 are. The first frame 84 is fixed to the first lens frame 66.

The fixation frame 74 is disposed closer to the object side than the third lens frame 70 is. The third lens frame 70 is fixed to an end portion of the fixation frame 74 that is on the image formation side. The second lens frame 68 is disposed inside the fixation frame 74. Specifically, the first frame 84 of the second lens frame 68 is disposed inside the fixation frame 74. The second lens frame 68 is supported to be movable in the optical axis direction with respect to the fixation frame 74. The fixation frame 74 is an example of a “support member” according to an embodiment of the present disclosed technology.

The cam tube 76 is disposed outside the fixation frame 74. In the description of the present specification, the term “outside” means “outside in the radial direction” unless there is no description in which a direction is specified. The cam tube 76 is supported to be rotatable around the optical axis direction with respect to the fixation frame 74. The focus ring 26 is connected to an outer side of the cam tube 76. The cam tube 76 integrally rotates with the focus ring 26. The cam tube 76 is an example of a “rotary member” according to an embodiment of the present disclosed technology.

The cam tube 76 includes a positioning portion 92. The positioning portion 92 is provided at an end portion of the cam tube 76 that is on the object side. The positioning portion 92 has a bayonet structure, for example. The bayonet structure is a structure including a plurality of claws 92A disposed at intervals in a circumferential direction of the cam tube 76. The number of the plurality of claws 92A is, for example, two. The two claws 92A are disposed to face each other in a radial direction of the cam tube 76. The number of the plurality of claws 92A may be any number. Each of the claws 92A protrudes toward a radially inner side of the cam tube 76.

A groove 94 is formed on the fixation frame 74, and each of the claws 92A is engaged with the groove 94. In addition, a third flange 88 is formed at an end portion of the fixation frame 74 that is on the image formation side, and an end portion of the cam tube 76 that is on the image formation side abuts the third flange 88 from the object side. Accordingly, the cam tube 76 is positioned with respect to the fixation frame 74 in the optical axis direction.

The movement member 78 is a distal end member positioned at an end portion of the lens mechanism 16 that is on the object side (that is, a tip portion of the lens mechanism 16). The movement member 78 is a member related to an accessory member that affects the optical performance of the first lenses 60, the second lenses 62, and the third lenses 64. As an example of a member related to the accessory member, the movement member 78 may be a lens hood or may be an attachment member to which various optical members can be attached. In addition, the optical member may be, for example, an optical filter. The movement member 78 is positioned on the object side with respect to the second lens frame 68. The specific gravity of the movement member 78 is equal to or smaller than the specific gravity of the cam tube 76. For example, the specific gravity of the movement member 78 is smaller than the specific gravity of the cam tube 76, and the movement member 78 is lighter than the cam tube 76. Note that the movement member 78 may be heavier than the cam tube 76.

The movement member 78 includes a body portion 96 and a tip portion 98. The tip portion 98 extends toward the object side from the body portion 96. The movement member 78 is disposed outside the fixation frame 74 while being disposed inside the lens barrel 27. Specifically, the body portion 96 of the movement member 78 is disposed outside the fixation frame 74 while being disposed inside the lens barrel 27. The tip portion 98 protrudes toward the object side with respect to the fixation frame 74 and the lens barrel 27. The movement member 78 is supported to be movable in the optical axis direction with respect to the fixation frame 74.

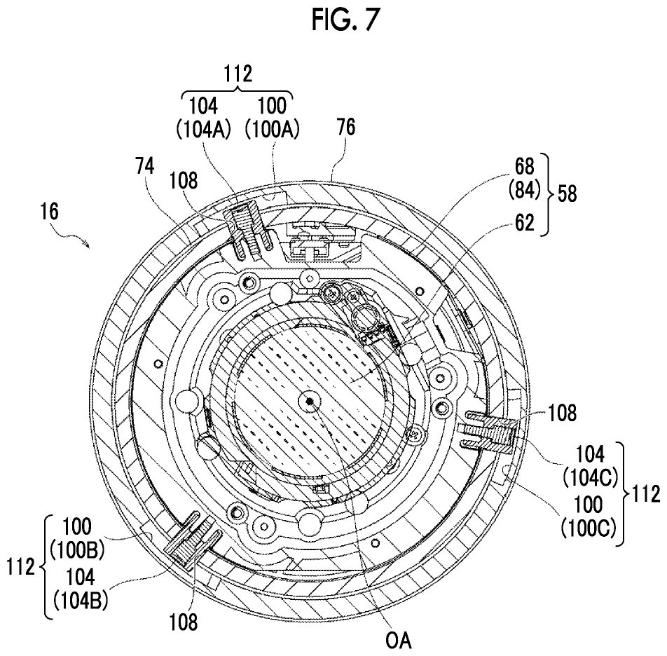

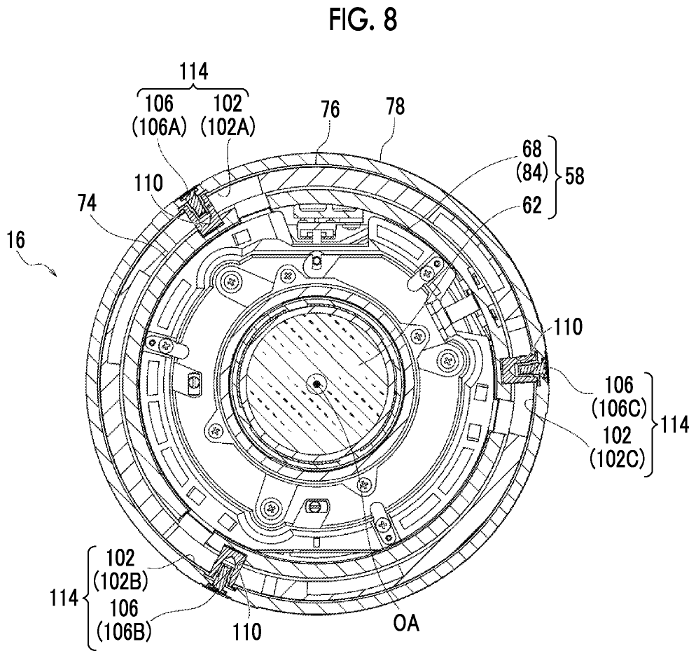

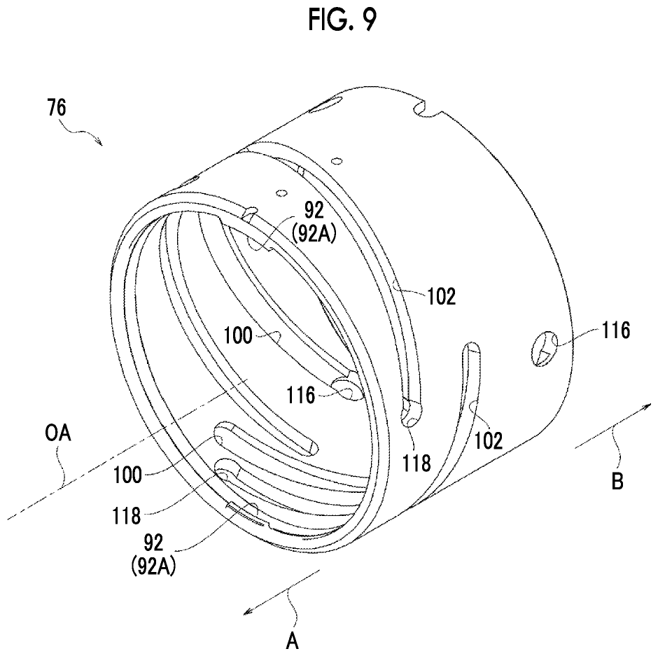

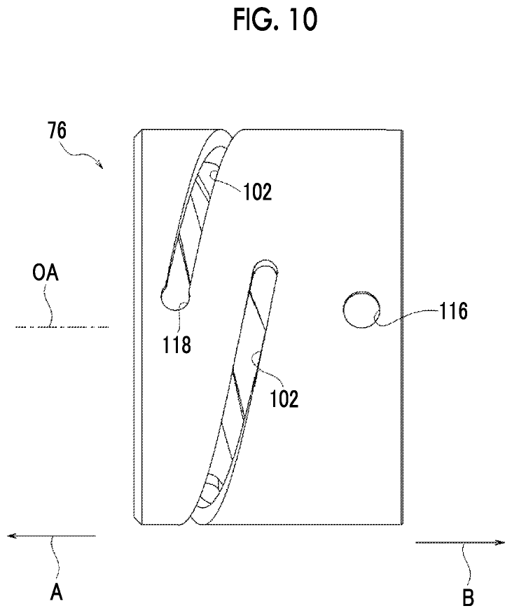

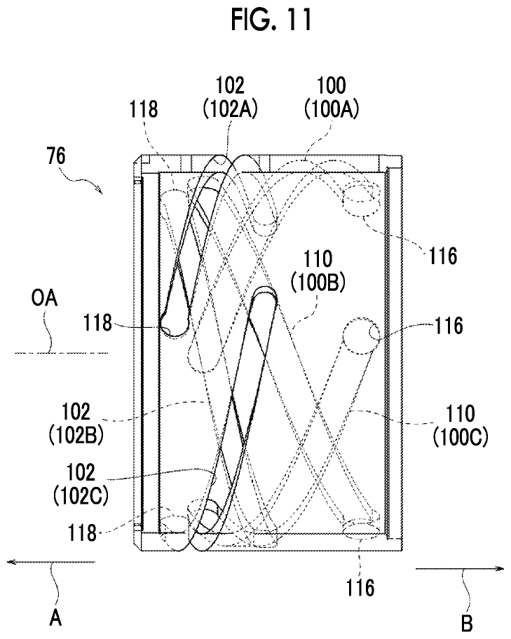

FIG. 7 shows a cross-sectional view of the lens mechanism 16 which is taken along line F7-F7 in FIG. 5 and FIG. 8 shows a cross-sectional view of the lens mechanism 16 which is taken along line F8-F8 in FIG. 5. In addition, FIG. 9 shows a perspective view of the cam tube 76 and FIGS. 10 and 11 show side views of the cam tube 76. Note that in FIG. 11, a plurality of first cam grooves 100 and a plurality of second cam grooves 102 formed in the cam tube 76 shown in FIG. 10 are shown with hidden lines.

The cam tube 76 includes the plurality of first cam grooves 100 that engage with the second lens frame 68 and the plurality of second cam grooves 102 that engage with the movement member 78. The first cam groove 100 is an example of a “first groove” according to an embodiment of the present disclosed technology, and the second cam groove 102 is an example of a “second groove” according to an embodiment of the present disclosed technology. The second lens frame 68 includes a plurality of first cam shafts 104 as components engaging with the first cam grooves 100 respectively and the movement member 78 includes a plurality of second cam shafts 106 as components engaging with the second cam grooves 102 respectively. The first cam shaft 104 is an example of a “first engaging member” according to an embodiment of the present disclosed technology and the second cam shaft 106 is an example of a “second engaging member” according to an embodiment of the present disclosed technology.

For example, each of the number of the plurality of first cam grooves 100 and the number of the plurality of second cam grooves 102 is three, and each of the number of the plurality of first cam shafts 104 and the number of the plurality of second cam shafts 106 is also three. The number of the plurality of first cam grooves 100 and the number of the plurality of second cam grooves 102 may be any number and the number of the plurality of first cam shafts 104 and the number of the plurality of second cam shafts 106 may also be any number.

The plurality of first cam shafts 104 are disposed at equal intervals in a circumferential direction of the second lens frame 68. In the description of the present specification, the meaning of “being at equal intervals” includes not only “being at equal intervals” but also “being at equal intervals with an error generally acceptable in a technical field to which the present disclosed technology belongs to an extent that is not inconsistent with the gist of the present disclosed technology”.

Each of the first cam shafts 104 protrudes toward the outside of the second lens frame 68. The first cam shafts 104 are respectively inserted into the first cam grooves 100 to engage with the first cam grooves 100. With the first cam shafts 104 respectively engaging with the first cam grooves 100, the focus lens group 58 including the second lens frame 68 and the second lenses 62 is supported in a state of being hung with respect to a structure including the fixation frame 74 and the cam tube 76.

The plurality of second cam shafts 106 are disposed at equal intervals in a circumferential direction of the movement member 78. Each of the second cam shafts 106 protrudes toward the inside of the movement member 78. The second cam shafts 106 are respectively inserted into the second cam grooves 102 to engage with the second cam grooves 102.

Hereinafter, in a case where the plurality of first cam grooves 100 need to be distinguished from each other for description, the plurality of first cam grooves 100 will be referred to as a first cam groove 100A, a first cam groove 100B, and a first cam groove 100C. In addition, in a case where the plurality of second cam grooves 102 need to be distinguished from each other for description, the plurality of second cam grooves 102 will be referred to as a second cam groove 102A, a second cam groove 102B, and a second cam groove 102C.

In addition, in a case where the plurality of first cam shafts 104 need to be distinguished from each other for description, the plurality of first cam shafts 104 will be referred to as a first cam shaft 104A, a first cam shaft 104B, and a first cam shaft 104C. In addition, in a case where the plurality of second cam shafts 106 need to be distinguished from each other for description, the plurality of second cam shafts 106 will be referred to as a second cam shaft 106A, a second cam shaft 106B, and a second cam shaft 106C.

The first cam shaft 104A is disposed at a position corresponding to the position of the second cam shaft 106A in a circumferential direction of the lens mechanism 16, the first cam shaft 104B is disposed at a position corresponding to the position of the second cam shaft 106B in the circumferential direction of the lens mechanism 16, and the first cam shaft 104C is disposed at a position corresponding to the position of the second cam shaft 106C in the circumferential direction of the lens mechanism 16. The second cam shafts 106 are respectively positioned on the object side with respect to the first cam shafts 104.

The fixation frame 74 includes a plurality of first long holes 108 and a plurality of second long holes 110. Each of the number of the plurality of first long holes 108 and the number of the plurality of second long holes 110 is three. The number of the plurality of first long holes 108 and the number of the plurality of second long holes 110 may be any number. Each of the first long holes 108 penetrates the fixation frame 74 in a radial direction and extends in the optical axis direction. Each of the second long holes 108 is formed in, for example, a groove shape having a bottom portion and extends in the optical axis direction.

The first cam shafts 104 are respectively inserted into the first long holes 108 and are movable in the optical axis direction with respect to the fixation frame 74. Similarly, the second cam shafts 106 are respectively inserted into the second long holes 110 and are movable in the optical axis direction with respect to the fixation frame 74. The first long holes 108 and the second long holes 110 are examples of a “long hole” according to an embodiment of the present disclosed technology.

Note that common long holes may be formed with respect to the first cam shafts 104 and the second cam shafts 106 although the first long holes 108 and the second long holes 110 are separately formed with respect to the first cam shafts 104 and the second cam shafts 106 in the present embodiment. The long holes in such a case are examples of a “long hole” according to an embodiment of the present disclosed technology.

Each of the first cam grooves 100 and the second cam grooves 102 is formed in a helical shape that is helical around the optical axis direction. The plurality of first cam grooves 100 are formed independently of each other. Similarly, the plurality of second cam grooves 102 are formed independently of each other. The first cam groove 100A corresponds to the second cam groove 102A, the first cam groove 100B corresponds to the second cam groove 102B, and the first cam groove 100C corresponds to the second cam groove 102C. Each of the first cam grooves 100 is formed independently of the corresponding second cam groove 102. In addition, each of the second cam grooves 102 is positioned on the object side with respect to the corresponding first cam groove 100.

In a case where the cam tube 76 rotates integrally with the focus ring 26, each of the first cam shafts 104 moves relative to the first cam grooves 100 and thus the focus lens group 58 including the second lens frame 68 and the second lenses 62 moves in the optical axis direction. In addition, in a case where the cam tube 76 rotates integrally with the focus ring 26, each of the second cam shafts 106 moves relative to the second cam grooves 102 and thus the movement member 78 moves in the optical axis direction.

That is, the first cam shafts 104 and the first cam grooves 100 constitute a first cam mechanism 112 that moves the focus lens group 58 in the optical axis direction as the cam tube 76 rotates. In addition, the second cam shafts 106 and the second cam grooves 102 constitute a second cam mechanism 114 that moves the movement member 78 in the optical axis direction as the cam tube 76 rotates. In addition, a cam mechanism that moves the focus lens group 58 and the movement member 78 together in the same optical axis direction is realized by the first cam mechanism 112 and the second cam mechanism 114. The first cam mechanism 112 and the second cam mechanism 114 are examples of a “cam mechanism” according to an embodiment of the present disclosed technology.

In addition, a first helical shape, which is the helical shape of the first cam grooves 100, is different from a second helical shape, which is the helical shape of the second cam grooves 102. Specifically, a first pitch, which is the cam pitch of the first cam grooves 100, is different from a second pitch, which is the cam pitch of the second cam grooves 102. More specifically, the second pitch is smaller than the first pitch. The cam pitch is the pitch of a helix and means a distance by which a portion of a helical shape advances in an axial direction of the helical shape in a case where the helical shape rotates once.

In addition, each first cam groove 100 is a groove (that is, a bottomed groove) that includes a bottom portion over the entire length of the first cam groove 100 in a lengthwise direction. Meanwhile, each second cam groove 102 is a groove (that is, a bottomless groove) that penetrates the cam tube 76 in the radial direction over the entire length of the second cam groove 102 in a lengthwise direction. Note that a first through-hole 116 penetrating the cam tube 76 in the radial direction is formed at one end portion of the first cam groove 100 in the lengthwise direction and a second through-hole 118 penetrating the cam tube 76 in the radial direction is formed at one end portion of the second cam groove 102 in the lengthwise direction.

The first through-hole 116 is a hole for attachment used to attach the first cam shaft 104 to the second lens frame 68 from the outside of the cam tube 76 in a state after assembly of the lens mechanism 16 and the second through-hole 118 is a hole for processing used in a case where processing in which the second cam groove 102 is formed from the one end portion of the second cam groove 102 in the lengthwise direction is to be started.

In addition, a first width, which is the width of the first cam groove 100, is different from a second width, which is the width of the second cam groove 102. Specifically, the second width is smaller than the first width.

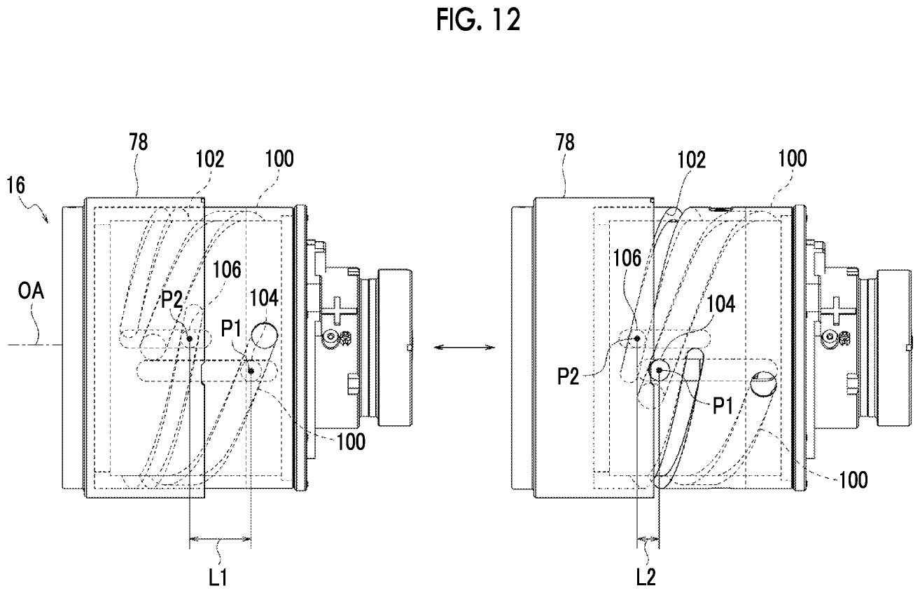

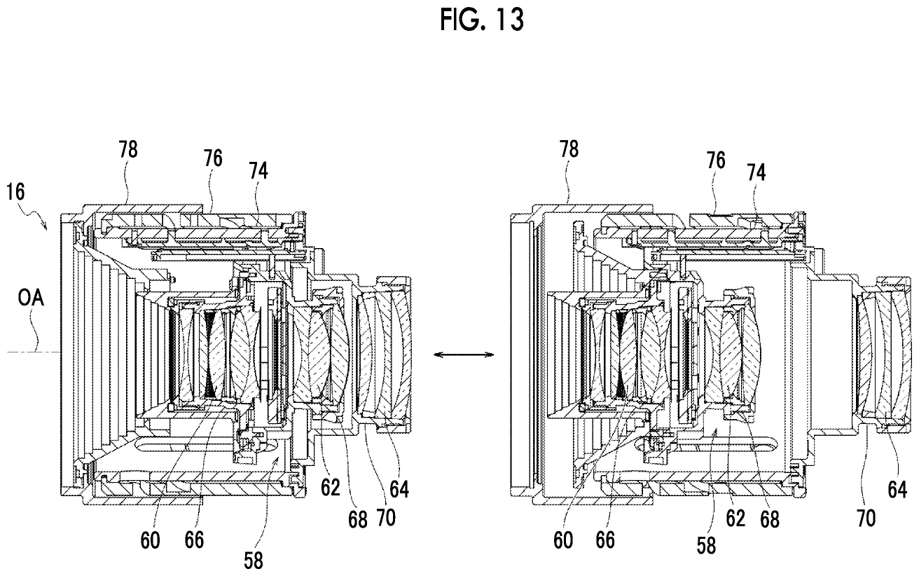

FIGS. 12 and 13 show the way in which the lens mechanism 16 is operated. FIG. 12 shows a side view of the lens mechanism 16 and FIG. 13 shows a longitudinal cross-sectional view of the lens mechanism 16. The left sides of FIGS. 12 and 13 show the state of the lens mechanism 16 in the case of infinite-distance imaging and the right sides of FIGS. 12 and 13 show the state of the lens mechanism 16 in the case of short-distance imaging.

In a case where infinite-distance imaging is to be performed, the second lens frame 68 and the movement member 78 are moved to the image formation side which is opposite to the object side. Meanwhile, in a case where short-distance imaging is to be performed, the second lens frame 68 and the movement member 78 are moved to the object side. The state of the lens mechanism 16 in the case of infinite-distance imaging is an example of a first state according to an embodiment of the present disclosed technology and the state of the lens mechanism 16 in the case of short-distance imaging is an example of a second state according to an embodiment of the present disclosed technology.

In FIGS. 12 and 13, a first engagement position P1 is a position (for example, the position of a central axis of the first cam shaft 104) where the second lens frame 68 and the first cam groove 100 engage with each other. In addition, a second engagement position P2 is a position (for example, the position of a central axis of the second cam shaft 106) where the movement member 78 and the second cam groove 102 engage with each other. As described above, the second lens frame 68 has the first engagement position P1 which is a position where the second lens frame 68 engages with the first cam groove 100 and the movement member 78 has the second engagement position P2 which is a position where the movement member 78 engages with the second cam groove 102.

In addition, in the lens mechanism 16, a distance between the first engagement position P1 and the second engagement position P2 in the optical axis direction differs between the case of the infinite-distance imaging and the case of the short-distance imaging since the second pitch, which is the cam pitch of the second cam groove 102, is smaller than the first pitch, which is the cam pitch of the first cam groove 100. Specifically, in a case where a distance between the first engagement position P1 and the second engagement position P2 in the optical axis direction in a state where the infinite-distance imaging is performed is a first distance L1 and a distance between the first engagement position P1 and the second engagement position P2 in the optical axis direction in a state where the short-distance imaging is performed is a second distance L2, the second distance L2 is smaller than the first distance L1.

That is, in a case where a transition from a state where the infinite-distance imaging is performed to a state where the short-distance imaging is performed is made, the movement member 78 moves by a shorter distance than the second lens frame 68. Note that the first engagement position P1 and the second engagement position P2 in a state where the infinite-distance imaging is performed are positioned closer to the image formation side than the first engagement position P1 and the second engagement position P2 in a state where the short-distance imaging is performed are.

Next, the effects of the present embodiment will be described.

In the lens device 12 according to the present embodiment, the lens mechanism 16 includes the second lens frame 68 that holds the second lenses 62, the cam tube 76 that rotates around the optical axis direction, and the focus ring 26 that is connected to an outer side of the cam tube 76. The cam tube 76 includes the first cam grooves 100 and the first cam shafts 104 provided at the second lens frame 68 engage with the first cam grooves 100. Therefore, in a case where the focus ring 26 is operated in a rotation direction by a user or the like, the first cam shafts 104 move along the first cam grooves 100 as the focus ring 26 and the cam tube 76 rotate, so that the focus lens group 58 including the second lens frame 68 and the second lenses 62 can be moved in the optical axis direction. Accordingly, a user or the like can focus on a subject manually.

In addition, the lens mechanism 16 includes the movement member 78 positioned at an end portion of the lens mechanism 16 that is on the object side. The cam tube 76 includes the second cam grooves 102 and the second cam shafts 106 provided at the movement member 78 engage with the second cam grooves 102. Therefore, in a case where the focus ring 26 is operated in the rotation direction by a user or the like, the second cam shafts 106 move along the second cam grooves 102 as the focus ring 26 and the cam tube 76 rotate, so that the movement member 78 can be moved in the optical axis direction.

As described above, the cam tube 76 includes the first cam grooves 100 engaging with the second lens frame 68 and the second cam grooves 102 engaging with the movement member 78. Therefore, movement of the second lens frame 68 and movement of the movement member 78 can be performed independently of each other structurally.

In addition, the first cam grooves 100 and the second cam grooves 102 are formed at the common cam tube 76. In addition, the first cam grooves 100 and the second cam grooves 102 constitute a cam mechanism that moves the second lens frame 68 and the movement member 78 together with each other in the optical axis direction as the cam tube 76 rotates. Therefore, the number of components can be reduced in comparison with, for example, a case where the first cam grooves 100 and the second cam grooves 102 are formed at separate members.

In addition, the lens device 12 includes the lens mechanism 16, the tilt mechanism 18 that tilts the lens mechanism 16, and the shift mechanism 20 that shifts the lens mechanism 16. Therefore, it is possible to perform tilt imaging which is imaging performed in a state where the lens mechanism 16 is tilted by the tilt mechanism 18 and shift imaging which is imaging performed in a state where the shift mechanism 20 is shifted by the shift mechanism 20.

In addition, the lens device 12 includes the revolving mechanism 22 that rotates the tilt mechanism 18 and the shift mechanism 20 around the optical axis direction. Therefore, it is possible to change a direction in which the lens mechanism 16 is tilted by rotating the tilt mechanism 18 with the revolving mechanism 22. In addition, it is possible to change a direction in which the lens mechanism 16 is shifted by rotating the shift mechanism 20 with the revolving mechanism 22.

Meanwhile, in the case of a so-called tilt-shift lens camera like the imaging apparatus 10 according to the present embodiment, infinite-distance imaging and short-distance imaging may be performed with the imaging apparatus 10 fixed to a tripod or the like. Here, in a case where the position of the centroid of the imaging apparatus 10 differs between the case of the infinite-distance imaging and the case of the short-distance imaging, the state of the imaging apparatus 10 set by a photographer is changed. Therefore, it is necessary to reset the state of the imaging apparatus 10, which may hinder imaging from being performed smoothly. Therefore, the smaller a degree to which the position of the centroid of the imaging apparatus 10 differs between the case of the infinite-distance imaging and the case of the short-distance imaging is, the more smoothly the imaging can be performed, which results in a higher definition.

Here, in a case where the first pitch, which is the cam pitch of the first cam grooves 100, and the second pitch, which is the cam pitch of the second cam grooves 102, are the same as each other and a transition from a state where the infinite-distance imaging is performed to a state where the short-distance imaging is performed is made, the movement member 78 is moved to the object side by the same distance as the second lens frame 68. In this case, the entire length of the imaging apparatus 10 is increased in comparison with a case where the moving distance of the movement member 78 is smaller than the moving distance of the second lens frame 68 and thus the position of the centroid of the imaging apparatus 10 is moved to the object side. Therefore, the state of the imaging apparatus 10 set by the photographer may be changed. In this case, it is necessary to reset the state of the imaging apparatus 10, which may hinder imaging from being performed smoothly.

With regard to this, in the case of the lens mechanism 16 according to the present embodiment, the second pitch, which is the cam pitch of the second cam grooves 102, is smaller than the first pitch, which is the cam pitch of the first cam grooves 100. Therefore, an increase in distance (that is, the feeding amount of the movement member 78) by which the movement member 78 moves to the object side in the case of the short-distance imaging is suppressed in comparison with a case where the first pitch and the second pitch are the same as each other. Accordingly, it is possible to suppress an increase in entire length of the imaging apparatus 10.

Specifically, in a case where a distance between the first engagement position P1 and the second engagement position P2 in the optical axis direction in a state where the infinite-distance imaging is performed is the first distance L1 and a distance between the first engagement position P1 and the second engagement position P2 in the optical axis direction in a state where the short-distance imaging is performed is the second distance L2, the second distance L2 is smaller than the first distance L1. Therefore, an increase in entire length of the imaging apparatus 10 in the case of the short-distance imaging is suppressed in comparison with a case where the first pitch and the second pitch are the same as each other. Accordingly, it is possible to suppress the position of the centroid of the imaging apparatus 10 being moved to the object side. Accordingly, it is possible to suppress a change in state of the imaging apparatus 10 set by a photographer and thus it is possible to save the effort of resetting the state of the imaging apparatus 10. As a result, it is possible to smoothly perform imaging.

In addition, the weight of the imaging apparatus 10 increases because the tilt mechanism 18, the shift mechanism 20, and the revolving mechanism 22 are provided. Therefore, in a case where the imaging apparatus 10 is dropped from a tripod or the like and falls onto the ground, the impact caused by fall is large in comparison with a case where the tilt mechanism 18, the shift mechanism 20, and the revolving mechanism 22 are not provided. In a case where the lens mechanism 16 receives an impact due to fall, the components of the lens mechanism 16 are inclined and/or shifted, which may result in a lower definition than a definition achieved in a case where the components are not inclined and/or shifted.

Here, it is conceivable to increase the thicknesses of the components as means for imparting, to the components of the lens mechanism 16, a stiffness enough to withstand the impact caused by fall. However, in such a case, the weight of the imaging apparatus 10 is also increased due to the increase in thicknesses of the components.

With regard to this, each first cam groove 100 is a groove (that is, a bottomed groove) that includes a bottom portion over the entire length of the first cam groove 100 in a lengthwise direction. Therefore, in comparison with, for example, a case where the first cam groove 100 is a groove (that is, a bottomless groove) that penetrates the cam tube 76 in a radial direction over the entire length of the first cam groove 100 in the lengthwise direction, the stiffness of a peripheral portion of the first cam groove 100 and the stiffness of the entire cam tube 76 can be improved.

Furthermore, since the first cam grooves 100 are grooves that engage with the second lens frame 68, an increase in supporting stiffness with respect to the second lenses 62 held by the second lens frame 68 can also be achieved with an increase in stiffness of the peripheral portions of the first cam grooves 100. As a result, the second lenses 62 inclined and/or shifted can be suppressed.

Meanwhile, each second cam groove 102 is a groove (that is, a bottomless groove) that penetrates the cam tube 76 in the radial direction over the entire length of the second cam groove 102 in a lengthwise direction. Therefore, in comparison with, for example, a case where the second cam groove 102 is a groove (that is, a bottomed groove) that includes a bottom portion over the entire length of the second cam groove 102 in a lengthwise direction, the weight of the cam tube 76 can be reduced and thus the lens mechanism 16 can be made light.

In addition, the second width, which is the width of the second cam grooves 102, is smaller than the first width, which is the width of the first cam grooves 100. Therefore, in comparison with, for example, a case where the first width and the second width are the same as each other, it is possible to improve the stiffness of peripheral portions of the second cam grooves 102 and the stiffness of the entire cam tube 76 while reducing the weight of the cam tube 76, by forming the second cam grooves 102 as bottomless grooves.

In addition, suppression of an increase in distance by which the movement member 78 moves to the object side, improvement in stiffness of the entire cam tube 76, and reduction in weight of the cam tube 76 are realized by devising the shapes of the first cam grooves 100 and the second cam grooves 102 as described above. Therefore, in comparison with, for example, a case where a structure in which the inner diameter of the cam tube 76 is limited is adopted, it is possible to suppress influence on the outer diameters of the first lenses 60 and the second lenses 62 disposed inside the cam tube 76.

In addition, the first cam grooves 100 are formed independently of the second cam groove 102. Therefore, in comparison with, for example, a case where the first cam grooves 100 and the second cam grooves 102 are continuously formed, it is possible to easily form the first cam grooves 100 and the second cam grooves 102, which are different from each other in cam pitch and width and are different in whether or not bottom portions are present, through groove processing.

In addition, the cam tube 76 includes the positioning portion 92 via which the cam tube 76 is positioned with respect to the fixation frame 74 in the optical axis direction. The positioning portion 92 includes the plurality of claws 92A and the plurality of claws 92A engage with the groove 94 formed at the fixation frame 74. Therefore, it is possible to remove the cam tube 76 from the fixation frame 74 by disengaging the plurality of claws 92A and the groove 94 from each other.

In addition, the first flange 54 is formed at an end portion of the lens barrel 27 that is on the image formation side and the second flange 56 is formed at an end portion of the tilt-shift unit 17 that is on the object side. In addition, the first flange 54 and the second flange 56 are fastened by screws or the like (not shown) in a state of overlapping with each other, so that the lens mechanism 16 and the tilt-shift unit 17 are fixed to each other. In addition, the third flange 88 is formed at an end portion (that is, an end portion close to the first flange 54 and the second flange 56) of the fixation frame 74 that is on the image formation side.

Here, an end portion of the cam tube 76 that is on the image formation side abuts the third flange 88 from the object side, and the positioning portion 92 is provided at an end portion of the cam tube 76 that is on the object side. Therefore, in comparison with, for example, a case where the positioning portion 92 is provided at the end portion of the cam tube 76 that is on the image formation side, the structures of peripheral portions of the first flange 54, the second flange 56, and the third flange 88 being complicated can be suppressed since the positioning portion 92 is provided on a side opposite to a side on which the first flange 54, the second flange 56, and the third flange 88 are provided. Accordingly, it is possible to suppress an increase in entire length and/or outer diameter of the lens mechanism 16.

Next, modification examples of the present embodiment will be described.

In the above-described embodiment, each first cam groove 100 is a groove that includes a bottom portion over the entire length of the first cam groove 100 in the lengthwise direction. However, the first cam groove 100 may be a groove of which a portion in the lengthwise direction of the first cam groove 100 includes a bottom portion. Accordingly, in comparison with a case where the first cam groove 100 is a groove that includes a bottom portion over the entire length of the first cam groove 100 in the lengthwise direction, the cam tube 76 can be made light. In addition, in comparison with a case where the first cam groove 100 is a groove that penetrates the cam tube 76 in the radial direction over the entire length of the first cam groove 100 in the lengthwise direction, the stiffness of the cam tube 76 can be improved.

In addition, in the above-described embodiment, each second cam groove 102 is a groove that penetrates the cam tube 76 in the radial direction over the entire length of the second cam groove 102 in the lengthwise direction. However, the second cam groove 102 may be a groove of which a portion in the lengthwise direction of the second cam groove 102 penetrates the cam tube 76 in the radial direction. Accordingly, in comparison with a case where the second cam groove 102 is a groove that penetrates the cam tube 76 in the radial direction over the entire length of the second cam groove 102 in the lengthwise direction, the stiffness of the cam tube 76 can be improved. In addition, in comparison with a case where the second cam groove 102 is a groove that includes a bottom portion over the entire length of the second cam groove 102 in the lengthwise direction, the cam tube 76 can be made light.

In addition, in the above-described embodiment, the second width, which is the width of the second cam grooves 102, is smaller than the first width, which is the width of the first cam grooves 100. However, the first width and the second width may be the same as each other.

In addition, in the above-described embodiment, the first distance L1 is a distance between the first engagement position P1 and the second engagement position P2 in the optical axis direction in a state where the infinite-distance imaging is performed. However, the first distance L1 may be such a distance in a state other than the state where the infinite-distance imaging is performed.

In addition, in the above-described embodiment, the second distance L2 is a distance between the first engagement position P1 and the second engagement position P2 in the optical axis direction in a state where the short-distance imaging is performed. However, the second distance L2 may be such a distance in a state other than the state where the short-distance imaging is performed.

In addition, in the above-described embodiment, the revolving mechanism 22 is a mechanism that rotates the tilt mechanism 18 and the shift mechanism 20 around the optical axis direction. However, the revolving mechanism 22 may be a mechanism that rotates any one of the tilt mechanism 18 or the shift mechanism 20 around the optical axis direction.

In addition, the above-described embodiment and a plurality of modification examples may be combined as appropriate.

Contents described and illustrated above are for detailed description of a part according to the present disclosed technology and are merely an example of the present disclosed technology. For example, description of the above-described configurations, functions, actions, and effects is description related to an example of configurations, functions, actions, and effects of a part according to the present disclosed technology. Therefore, it is a matter of course that an unnecessary part of the contents described and illustrated above may be deleted, a new element may be added, and replacement may be made without departing from the spirit of the present disclosed technology. In addition, in order to avoid complication and facilitate the understanding of a portion according to the present disclosed technology, regarding the contents described and illustrated above, description related to common technical knowledge or the like which does not need to be described to enable implementation of the present disclosed technology has been omitted.

In the description of the present specification, “A and/or B” has the same meaning as “at least one of A or B”. That is, “A and/or B” means “A, B, or a combination of A and B”. In addition, in the description of the present specification, the same concept as in the case of “A and/or B” applies to a case where three or more matters are expressed together by “and/or”.

All publications, patent applications, and technical standards described in the present specification are incorporated herein by reference to the same extent as if each publication, patent application, or technical standard was specifically and individually indicated to be incorporated by reference.

What is claimed is:

1. A lens device comprising:
a lens mechanism;
a tilt mechanism that tilts the lens mechanism; and
a shift mechanism that shifts the lens mechanism;
wherein the lens mechanism includes
a lens holding member that holds a lens and that moves in an optical axis direction,
a movement member that moves in the optical axis direction and that is positioned at an end portion of the lens mechanism that is on an object side, and
a rotary member that rotates around the optical axis direction, and
the rotary member includes a first groove that engages with the lens holding member and a second groove that engages with the movement member.

2. The lens device according to claim 1,
wherein a specific gravity of the movement member is equal to or smaller than a specific gravity of the rotary member.

3. The lens device according to claim 1,
wherein the movement member is a member related to an accessory member that affects an optical performance of the lens.

4. The lens device according to claim 1,
wherein the movement member is a lens hood.

5. The lens device according to claim 1,
wherein the movement member is an attachment member to which an optical member is attachable.

6. The lens device according to claim 1,
wherein the first groove and the second groove constitute a cam mechanism that moves the lens holding member and the movement member together with each other in the optical axis direction as the rotary member rotates.

7. The lens device according to claim 1,
wherein the first groove is a first cam groove along which the lens holding member is moved in the optical axis direction as the rotary member rotates, and
the second groove is a second cam groove along which the movement member is moved in the optical axis direction as the rotary member rotates.

8. The lens device according to claim 1,
wherein a first pitch, which is a cam pitch of the first groove, is different from a second pitch, which is a cam pitch of the second groove.

9. The lens device according to claim 8,
wherein the second pitch is smaller than the first pitch.

10. The lens device according to claim 1,
wherein the lens holding member has a first engagement position which is a position where the lens holding member engages with the first groove,
the movement member has a second engagement position which is a position where the movement member engages with the second groove, and
a second distance is smaller than a first distance, where the first distance is a distance between the first engagement position and the second engagement position in the optical axis direction in a first state, which is a state where the lens holding member and the movement member have been moved to an image formation side opposite to the object side and the second distance is a distance between the first engagement position and the second engagement position in the optical axis direction in a second state, which is a state where the lens holding member and the movement member have been moved to the object side.

11. The lens device according to claim 10,
wherein the first engagement position and the second engagement position in the first state are positioned closer to the image formation side than the first engagement position and the second engagement position in the second state are.

12. The lens device according to claim 10,
wherein the first state is a state where infinite-distance imaging is performed, and
the second state is a state where short-distance imaging is performed.

13. The lens device according to claim 1,
wherein the first groove is a groove of which at least a portion in a lengthwise direction of the first groove includes a bottom portion.

14. The lens device according to claim 1,
wherein the first groove is a groove that includes a bottom portion over an entire length of the first groove in a lengthwise direction.

15. The lens device according to claim 1,
wherein the second groove is a groove of which at least a portion in a lengthwise direction of the second groove penetrates the rotary member in a radial direction.

16. The lens device according to claim 1,
wherein the second groove is a groove that penetrates the rotary member in a radial direction over an entire length of the second groove in a lengthwise direction.

17. The lens device according to claim 1,
wherein a first width, which is a width of the first groove, is different from a second width, which is a width of the second groove.

18. The lens device according to claim 17,
wherein the second width is smaller than the first width.

19. The lens device according to claim 1,
wherein the first groove is formed independently of the second groove.

20. The lens device according to claim 1,
wherein the second groove is positioned on the object side with respect to the first groove.

21. The lens device according to claim 1,
wherein the lens holding member includes a first engaging member that engages with the first groove, and
the movement member includes a second engaging member that engages with the second groove.

22. The lens device according to claim 1, further comprising:
a support member that supports the lens holding member, the movement member, and the rotary member.

23. The lens device according to claim 22,
wherein the rotary member includes a positioning portion via which the rotary member is positioned with respect to the support member in the optical axis direction.

24. The lens device according to claim 23,
wherein the positioning portion is provided at an end portion of the rotary member that is on the object side.

25. The lens device according to claim 22,
wherein the lens holding member is disposed inside the support member, and the movement member and the rotary member are disposed outside the support member.

26. The lens device according to claim 22,
wherein the lens holding member includes a first engaging member that engages with the first groove,
the movement member includes a second engaging member that engages with the second groove,
the support member includes a long hole that penetrates the support member in a radial direction and that extends in the optical axis direction, and
the first engaging member and the second engaging member are inserted into the long hole.
